(19) United States
(12) Patent Application Publication
(10) Pub. No.: US 2021/0342936 A1
(43) Pub. Date: Nov. 4, 2021

(54) AUTOMATED TRANSFER BASED ON ENTITY ESTABLISHED TARGETS

(71) Applicant: Wells Fargo Bank, N.A., San Francisco, CA (US)

(72) Inventor: Brian Cariveau, San Francisco, CA (US)

(21) Appl. No.: 16/222,447

(22) Filed: Dec. 17, 2018

Related U.S. Application Data
(60) Provisional application No. 62/611,885, filed on Dec. 29, 2017.

(51) Int. Cl. G06Q 40/02; G06F 21/62; G06Q 20/10; G06Q 50/00

(52) U.S. Cl. CPC G06Q 40/02; G06F 21/6245; G06F 16/953; G06Q 50/01; G06Q 20/10

(57) ABSTRACT

A computer-implemented method may include receiving, over a network interface, a status update request from a user; in response to the request, updating a net worth calculation for the user; determining that the net worth calculation exceeds a first target of a set of net worth targets, and in response, presenting a dashboard user interface to the user, the dashboard user interface including: a first portion to present an indication that the user has met the first target; and a second portion requesting selection of a charity; receiving a selection of a charity through the second portion; initiating an electronic communication with the selected charity to transfer funds to the selected charity

### RELATED APPLICATIONS

This patent application claims the benefit of priority, under 35 U.S.C. § 119(e), to U.S. Provisional Patent Application Ser. No. 62/611,885, titled Automated Transfer based on Entity Established Targets,” filed on Dec. 29, 2017, which is incorporated by reference in its entirety

### BACKGROUND

A user may use an electronic application (e.g., a web application or app) to track the user's progress towards a goal. In some examples, the goal may be financial in nature while in others it may be a personal goal. The electronic application may act as an agent of the user to retrieve data associated with the user from other electronic applications.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 illustrates a schematic representation of devices interacting with a charity portal, according to various examples.

FIG. 2 illustrates a user account, according to various examples.

FIG. 3 is a dashboard user interface, according to various examples.

FIG. 4 illustrates a flowchart of a method to present a dashboard interface, according to various examples.

FIG. 5 is a block diagram illustrating an example machine upon which any one or more of the techniques (e.g., methodologies) discussed herein may be performed, according to an example embodiment.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Many companies have charitable giving campaigns or programs to invest in their local (or national) communities. In most cases, customers (also referred to as users herein) of the company are not involved in the process of charitable giving for the company. As a way of helping customers get involved, systems and methods described herein provide incentives to customers to reach certain targets. Upon reaching a target, a charitable donation may be made on behalf of the customer by the company to a charitable organization. In some examples, the target is a net worth target for the customer. The systems and methods are directed towards the technical solutions needed to overcome the technical challenges of facilitating the transfer on behalf of the customer and tracking net worth growth. For example, the solutions include electronic program-to-program communications between disparate computing systems, authentication techniques, and novel user interface designs to help assist the customer.

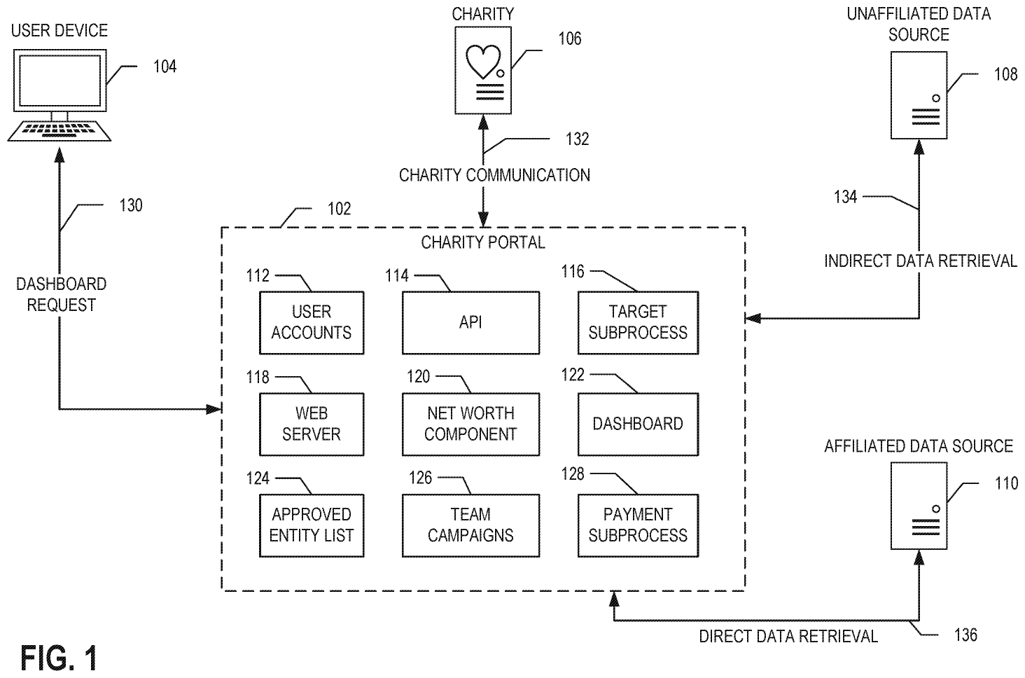

FIG. 1 illustrates a schematic representation of devices interacting with a charity portal 102. Charity portal 102, as illustrated, includes user accounts 112, API 114, target subprocess 116, web server 118, net worth component 120, dashboard 122, approved entity list 124, team campaigns 126, and payment subprocess 128. FIG. 1 also illustrates user device 104, charity server 106, unaffiliated, data source 108, and affiliated data source 110. Various communications may be exchanged between the components of FIG. 1 such as dashboard request 130, charity communication 132, indirect data retrieval 134, and direct data retrieval 136.

In various examples, charity portal 102 is used by a user to electronically link net worth growth targets of a user to charitable giving. The targets may be set by charity portal 102. Charity portal 102 may be a standalone computing system or part of a larger group of computing systems. Charity portal 102 may be affiliated with a financial institution, as discussed further herein.

For illustration purposes, charity portal 102 is illustrated as set of separate components, subprocesses, etc. However, the functionality of individual components may be performed by a single component. A component may represent computer program code that is executable by a processing unit (e.g., a core of a general purpose computer processor, a graphical processing unit, an application specific integrated circuit, etc.) The program code may be stored on a storage device and loaded into a memory of the processing unit for execution. Portions of the program code may be executed in a parallel across multiple processing units. Execution of the code may be performed on a single device or distributed across multiple devices. In some example, the program code is executed on a cloud platform (e.g., MICROSOFT AZURE® or AMAZON EC2®) using shared computing infrastructure.

The computing devices illustrated in FIG. 1 may communicate over a network (not shown). A network may include local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. A network may include a single local area network (LAN) or wide-area network (WAN), or combinations of LAN's or WAN's, such as the Internet.

Charity portal 102 may provide one or more Application Programming Interfaces (API) such as API 114 to respond to requests from user device 104, charity server 106, unaffiliated data source 108, and affiliated data source 110. Although not illustrated, charity server 106, affiliated data source 110, etc., may also implement their own APIs.

An API may provide a method for computing processes to exchange data. A web-based API, such as API 114, may permit communications between two or more computing devices via web server 118. The API may define a set of HTTP calls according to Representational State Transfer (RESTful) practices. A RESTful API may define various GET, PUT, POST, DELETE methods to create, replace, update, and delete data stored on a database of charity portal 102. For example, “GET/status/targetID/userID” may be used user device 104 to retrieve the status (e.g., met or unmet) for a net worth target of user associated with “userID.” The same endpoint may be reused to delete a target using “DELETE status/targetID/userID.” The paths and naming conventions described are for illustration purposes and other API function calls may be used without departing from the scope of this disclosure.

API 114 may transmit responses to requests for data according to the JavaScript Object Notation (JSON) format. Similarly, data transmitted via API 114—from user device 104, for example—may be encoded in the JSON format and submitted in the content portion of a PUT request. Because of the sensitive nature of data stored within user device 104, various security measures may be used to protect data at rest and in transmit. For example, API 114 may use tokens or API keys to ensure only authorized parties may retrieve or update data impact notification server 106. Additionally, data transmitted a the network may use a cryptographic protocol, such Secure Socket Layer (SSL) or Transport Layer Security (TLS). As a further security precaution, the transmitted data itself may be encrypted, separately from the SSL or TLS encryption. Public-key infrastructure (PKI) may be leveraged for SSI/TLS as well as the separate data encryption.

Web server 118 may be used to exchange information with users/computing devices via a network. Although generally discussed in the context of delivering webpages via the Hypertext Transfer Protocol (HTTP), other network protocols may be utilized by web servers 110 (e.g., File Transfer Protocol, Telnet, Secure Shell, etc.) A user may enter in a uniform resource identifier (URI) into a network browser (e.g., the INTERNET EXPLORER® web browser by Microsoft Corporation or SAFARI® web browser by Apple Inc.) that corresponds to the logical location (e.g., an Internet Protocol address) of charity portal 102 and request a dashboard. In response, web server 118 may transmit a web page that is rendered on a display device of user device 104 (e.g., a mobile phone, desktop computer, etc.).

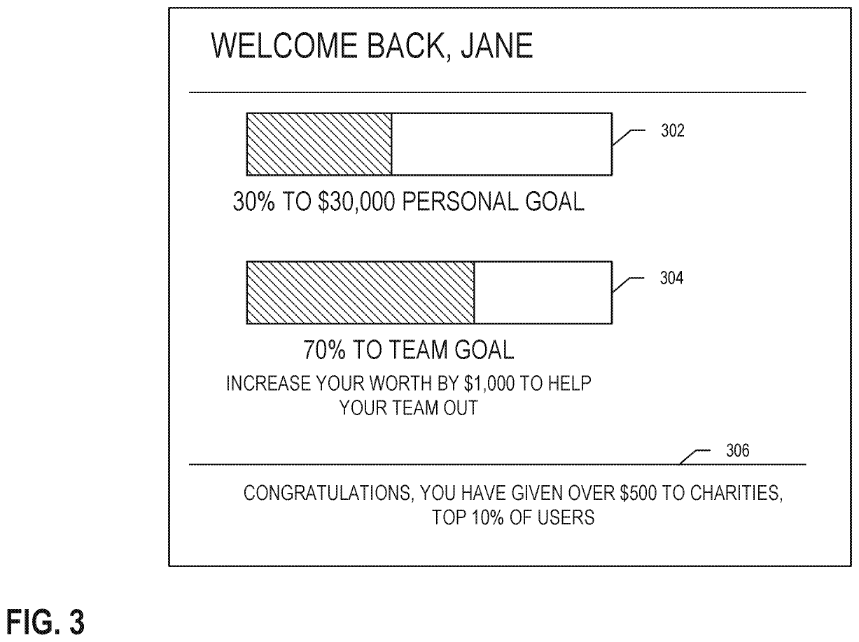

In response to a request from user device 104, dashboard 122 may be served via web server 118. Dashboard 122 may include a number of user interface elements that identify the user's progress with respect to a net worth targets and charitable giving. Some of the data included in dashboard 122 may be retrieved from user accounts 112. A more detailed example dashboard is presented in FIG. 3.

Data used in the charity portal 102 may be organized and stored in a variety of manners. For convenience, the organized collection of data is often described in the context of a database(s) with tables. The specific storage layout and model used in a database may take a number of forms—indeed, a database may utilize multiple models. The database may be, but is not limited to, a relational database (e.g., SQL), non-relational database (NoSQL) a flat file database, object model, document details model, or a file system hierarchy. The database may store data on one or more storage devices (e.g., a hard disk, random access memory (RAM), etc.). The storage devices may be in standalone arrays, part of one or more servers, and may be located in one or more geographic areas.

Net worth component 120 may perform a calculation of the current net worth of a user. In an example, current reflects the last time charity portal 102 updated the user's net worth. Charity portal 102 may update the net worth in response to events including receiving a request from user device 104 or charity portal 102 performing periodic background updates (e.g., daily). In an example, if a user has not logged into charity portal 102 within a threshold amount of time, net worth component 120 may perform an update of the user's net worth.

Any suitable technique for calculating net worth may be implemented by net worth component 120. For example, net worth component 120 may calculate the difference in value between the assets and debts held by a user (as stored in user accounts 112). An administrator of charity portal 102 may identify asset classes to include or exclude in the net worth calculation performed by net worth component 120 via an administrator interface served by web server 118.

Net worth component 120 may update the values of the debts and assets in user accounts 112 before performing the net worth calculation. Asset (e.g., vehicles, loans, retirement accounts, equities, etc.) may be determined by querying different data sources over a network.

Two types of data sources are illustrated in FIG. 1: affiliated and unaffiliated. The type data source may determine the data retrieval technique used for asset value retrieval. An affiliated data source may be a data source that is associated with charity portal 102. For example, a financial institution may provide charity portal 102 as a separate service—in addition to the financial institution's normal banking function. Accordingly, charity portal 102 may directly access a user's financial records for accounts managed by the financial institution (e.g., an affiliated data source).

In various examples, associated may mean that the affiliated data source and charity portal 102 have established a direct way to exchange the user's data. Direct may mean that charity portal 102 may access user's financial data on affiliated data source 110 using a token or direct API without screen scraping. Screen scraping may be a technique by which charity portal 102 logs into affiliated data source 110 via a webpage using credentials provided to charity portal 102 by the user. In effect, charity portal 102 is acting as the user. This technique may not be as efficient and may lead to errors when the unaffiliated data source 108 changes its webpage.

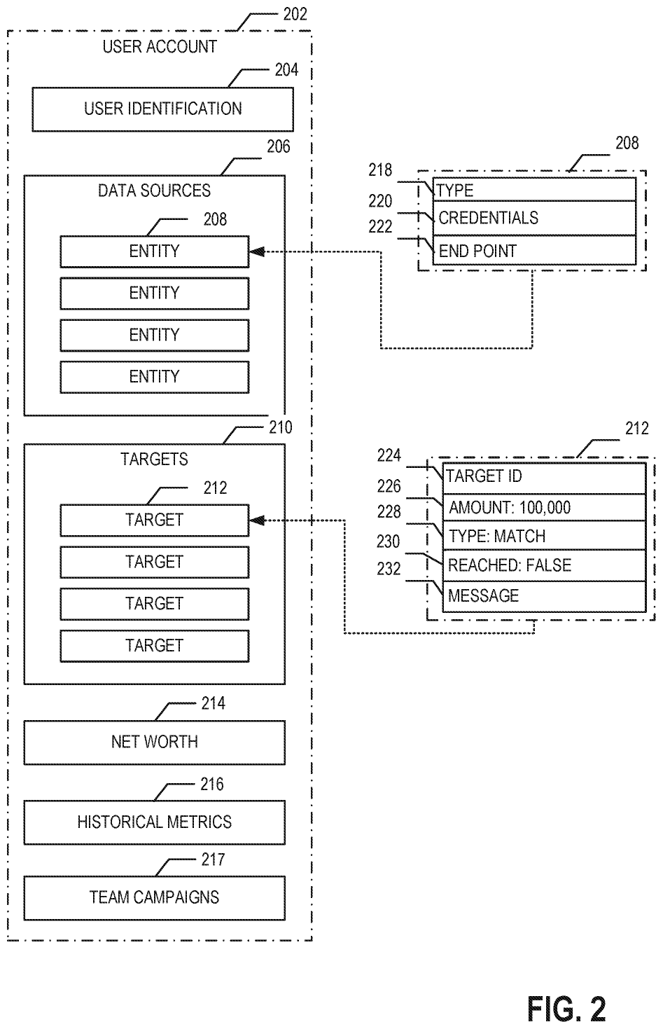

Target subprocess 116 may identify whether or not a user has reached a target net worth. For example, a set of targets may be stored as a database table within charity portal 102. Each target may include the net worth needed to trigger a corresponding amount to give to an entity (e.g., a 501(c)(3)charity). A target may include a type that indicates the source of funds to give to a target charity. A type may be funded by charity portal 102, the user, or a combination of the two (e.g., a match up to 10%). A target may be also associated with a nominal amount to give to an entity should the target be reached. This may be useful when the source of funds is the charity portal itself. A default amount to give may also be set. Target subprocess 116 may be run after net worth component 120 has updated the net worth of an individual by iterating through the targets in the table and comparing the target amount to the user's net worth. A more detailed look at targets is presented in the discussion of FIG. 2.

Approved entity list 124 may identify the entities that are approved to receive charitable gifts upon a user reaching a target. Potential fraud may be reduced by limiting the number of entities. For example, a user may create their own fraudulent charity and then charity portal 102 may unwittingly be giving money back to the user. This may occur when the given money originates from charity portal 102 as opposed to the user. A user may request that an entity be added to approved entity list 124 via dashboard 122. For example, a web page may be served with input fields designating the name, address, etc., of the requested charity.

Team campaigns 126 may identify campaigns that are based on the performance of a team of users (e.g., a business, group of friends, etc.). In some examples, targets may include additional criteria beyond a total net worth of the group—although that may still be a valid target criteria. For example, a target reachability criteria may include that a certain percentage of the group meet one of the individual net worth targets. Another criteria may be that each group member hit the their own respective next target net worth. Another criteria may be an increase in X dollars of a user's net worth since the beginning of a campaign.

An administrative user interface (UI) may be provided by charity portal 102 to manage a team. The UI may permit a user to establish a group and invite other users (e.g., via e-mail) to the team. The UI may be also include input elements to establish targets for the team and the reachability criteria for the targets. If the source of funds for an entity is charity portal 102, approval may be requested to administrators of charity portal 102 before a campaign is activated.

Users may adjust the granularity of information available to a team campaign via a user interface of charity portal 102. For example, after establish a team, charity portal 102 may transmit a request to each team member requesting authorization from the team member to access their financial data. The user may choose to only share whether or not they have hit a target, as opposed to the amount of the target. In an example, the user shares their net worth or the amount of the target the user last hit.

The dashboard for a user may illustrate progress on team campaigns the user is participating in. To protect the financial information of team members, the actual net worth of an individual team members may be obfuscated (e.g., a different scale beyond dollar may be used or only a graphic may be used). In some examples, whether or not other team members have met their individual goals is also hidden. The dashboard may illustrate the total amount given to entities since the start of the campaign.

Payment subprocess 128 may implement the transfer of funds on behalf of the user to a target entity. For example, in response to target subprocess 116 indicating that a target has been reached, an interface may be presented to the user (e.g., on the dashboard) with drop-down element to select one or entities in approved entity list 124. The interface may also include an input field to enter in an amount to give to each selected entity. The user may also input a source of funds to use for target entity. The user may select one of their assets as stored in user accounts 112 for payment, in an example. In an example, the fund transfer occurs automatically upon reaching the target without further input from the user.

Payment subprocess 128 may receive payment facilitation information from approved entity list 124 to initiate the payment. The payment facilitation information may include API commands for charity server 106 to begin a transfer of funds. The API may include variables for the amount and a user account number and routing number, a credit card number, etc., of a user stored in user accounts 112 or inputted as above. Payment subprocess 128 may then execute the API call to charity server 106 to initiate the transfer. If the target is a match type, an additional API call may be made with the payment information of charity portal 102 to initiate another transfer of funds.

FIG. 2 illustrates a user account, according to various examples. User account 202 may be stored in user accounts 112 of charity portal 102. User accounts 112 may store data on users that have established accounts with charity portal 102. Individual components that may make up a user account are detailed further in FIG. 2. User account 202 may include user identification 204, data sources 206, targets 210, net worth 214, historical metrics 216, and team campaigns 217. Data sources 206 may include a number of entities, such as entity 208, which in turns includes type 218, credentials 220, and end point 222. Target 212 may be one of the targets in targets 210 and identifies target ID 224, amount 226, type 228, reached status 230, and message 232.

User identification 204 may identify a user's credentials for logging into charity portal 102. The credentials may have been established during an account setup process served from web server 118. The account setup process may also include requests for the user to identify (e.g., input in a name) entities where the user has financial accounts. Entities may be banks, brokers, car dealerships, student loan servicers, etc. The identified entities may be stored as an entity in data sources 206. The setup process may request user credentials (e.g., credentials 220), an end point (e.g., a web site) to access information from the entity. In some examples, account numbers are also requested by the user.

Depending on the identity of the entity, charity portal 102 may store the entity as an affiliated or unaffiliated data source in type 218. For example, charity portal 102 may store a list of affiliated data sources that may be queried when the user adds a new data source. If the user does not know the end point (e.g., web address), charity portal 102 may also retrieve the end point based on the name supplied by the user.

Net worth component 120 may use the information in data sources 206 to retrieve values of assets held at the entities identified in data sources 206. For example, for an affiliated data source, a token may be issued by the data source tied to the user account. The token may be used by charity portal 102 over an API to retrieve the values. Screen scraping techniques may use user provided credentials for unaffiliated data sources. Charity portal 102 may present the values of the assets in a dashboard alongside a calculated net worth.

Data sources 206 may also store value of assets held at each entity for the user. In some examples, the value is only temporarily held as the net worth of a user is calculated. In this manner the user's privacy is maintained even if charity portal 102 is compromised. The user's privacy is even further secured by using tokens for affiliated data sources—as an entity can remotely deactivate a token.

Targets 210 may store instances of targets set by charity portal 102. In other words, charity portal 102 may store a definition of a target identifiable by an ID (e.g., target ID 224) and the copy of the target may be stored within targets 210. Default targets may be stored by charity portal 102. A user may set their own targets in an example. Amount 226 may be used by target subprocess 116 along with net worth 214 (as calculated by net worth component 120) to determine whether a target has been reached.

Type 228 indicates the type of the target-in this case a match. Additional details for a target may be stored depending on the type. For example, a match type may include the maximum amount of funds that will be matched by charity portal 102 if the target is reached. If the type is “Portal”, target 212 may include the amount to be donated by charity portal 102.

Reached status 230 may be a flag that indicates whether the target has ever been attained by the user. This may be useful when a user's net worth drops below amount 226 and then reaches the amount again in the future. In such a scenario, charity portal 102 would not initiate a second round of giving to a charity. Reached status 230 may also be stored as a percentage achieved towards the goal. This may be in addition to the overall flag of whether the target has been reached.

Message 232 may include a string to present to the user (e.g., on the dashboard) when the user reaches a target. The message may dependent on the type of the target. For example, “Congrats on reaching target, [financial institution] on your behalf, will give [amount] to a charity of your choice selected from approved charities” Or “Congrats, [financial institution] on your behalf, will match up to 10% or %500 dollars to a charity of your choice selected from approved charities.” Or “Congratulations, how much would like to give to a charity of your choice selected from approved charities?”

Historical metrics 216 may store data on historical giving attributable to the user. For example, historical metrics 216 may store how much has been given by year, by entity, total amount given, etc. Historical metrics 216 may also store data identifying when a target was reached. The amount given may be broken down between direct giving by the user and funds given by charity portal 102 (e.g., matched funds). If the user is part of any team campaigns, historical metrics related to such giving may be stored in a similar fashion (e.g., how much as the team given to an entity this year).

Team campaigns 217 may identify campaigns that the user is currently participating in. Team campaigns 217 may store their own information on targets similar to targets 210. A target in team campaigns 217 may track the current targets for the team as well as the individuals status with respect to the goal. For example, if each user needs to increase their net worth by $10,000, the target may have a group status (e.g., 35%) even if the user has already increased their net worth by $10,000 (e.g., 100% reached) since the beginning of the campaign.

Some other data not illustrated in user account 202 may include preferred charities of the user that are on the approved entity list. User account 202 may also include status information on entities that user has requested to be added to the approved entity list.

FIG. 3 is a dashboard user interface (UI), according to various examples. The UI illustrates a first portion 302, a second portion 304, and a third portion 306. The layout and information displayed in the UI is only an example and other layouts with more or fewer portions. Information may include, but is not limited to status of individual targets, status of team targets, overall net worth, and historical giving amounts. As illustrated in FIG. 3, first portion 302 displays a graphic illustrating the progress a user has made to an individual target, second portion 304 displays the progress towards a team goal, and third portion 306 displays some historical giving information.

When a user logs into charity portal 102, the presented information may animate some of the portions to show a change. For example, the shading in first portion 302 may increase towards the right edge of the rectangle proportionally to an updated percentage (e.g., 50% may mean 50% shaded).

Although a graphical UI is displayed in FIG. 3, other user interfaces may be implemented by charity portal 102. For example, a user may link (e.g., authorize access to) a social media account with charity portal 102. Then, when a user reaches a target, a message may be posted on behalf of the user to the social media account indicating the user just gave money to XYZ charity.

Another user interface may be with digital assistants. The user may link (e.g., authorize access) to a digital assistant during the account setup process. Then, the user may request (e.g., verbally, textually) an update with respect to their net worth or with respect to their next target via the digital assistant. The digital assistant may use API 114 to structure a request to charity portal 102 to retrieve the requested data and reply to the user.

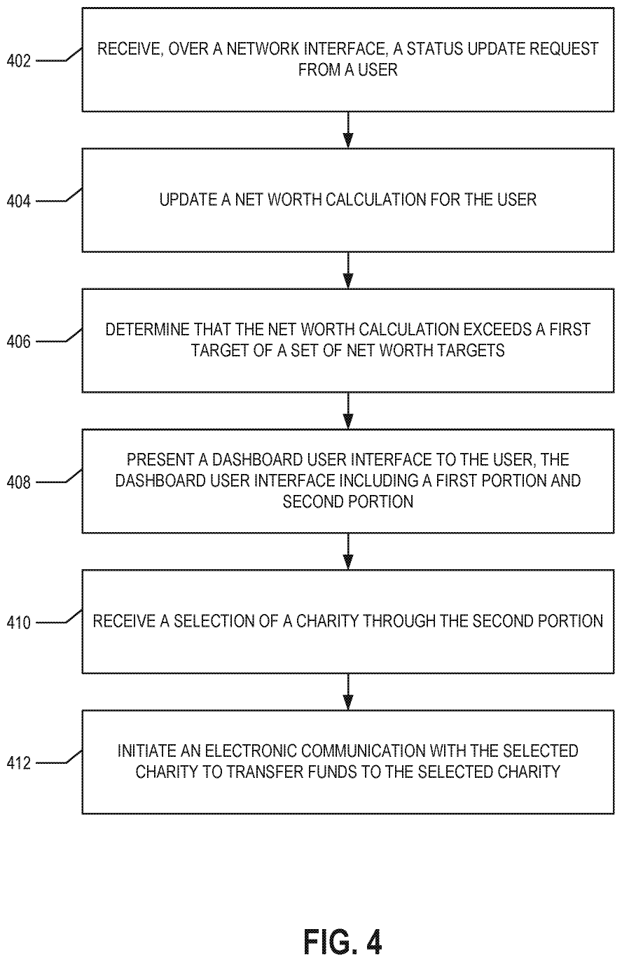

FIG. 4 illustrates a flowchart of a method to present a dashboard interface, according to various examples. The method may be embodied in a set of instructions stored in at least one non-transitory storage device of a computing device(s) such as charity portal 102. In an example, the computing device is a mobile device of a user that executes the operations in FIG. 4. The computing device(s) may have one or more processing units that execute the set of instructions to configure the one or more processing units to perform the operations illustrated in FIG. 4. To this end, the processing units may instruct other parts of the computing device to carry out the set of instructions. For example, the computing device may instruct a network device to transmit data to another computing device or the computing device may provide data over a display interface to present a user interface. In some examples, performance of the method may be split across multiple computing devices.

In an example, at operation 402, a status update request may be received over a network interface from a user. The status update request may be the user logging into a system such as charity portal 102. The status update may relate to the net worth of the user.

In an example, at operation 404, a net worth calculation may be updated for the user. A net worth calculation may perform the functionality described with respect to net worth component 120. The net worth of the use may be expressed as an amount of currency (e.g., dollars). For example, operation 404 may include querying a plurality of data sources for value information associated with the user. Each of the plurality of data sources may include a type of the data source. The type may be affiliated or unaffiliated. Affiliated data sources may be queried using a direct data retrieval method (e.g., API, tokens). Unaffiliated data sources may be queried using an indirect data retrieval method (e.g., screen scraping).

In an example, at operation 406, is determined that the net worth calculation exceeds a first target of a set of net worth targets. The targets may be stored as data structures on a storage device of charity portal 102. The net worth of the user may be compared to an amount field in the target data structure.

If it is determined that the net worth calculation exceeds the first target, a dashboard user interface may be presented to the user at operation 408. Presenting may include transmitting the dashboard user interface to a computing device of the user for rendering on the computing device of the user. For example, the dashboard may be served as a webpage. Presenting may include updating an application executing on a mobile device.

The dashboard user interface may include a number of portions. For example, a first portion may present an indication that the user has met the first target and a second portion may request selection of a charity. The first portion may include an animation indicating the target has been met. For example, a graphic may be shown filling completely up or stars may slide in from a corner of a display device, etc. Animations may also be used to show an increase in net worth. For example, a thermometer may be shown increasing in temperature (e.g., dollar amounts) to the calculated net worth.

The second portion may present a list of approved entities for giving to. In an example, if it is determined that the first target has not previously been reached before presenting the dashboard user interface. If the target has not been reached, a different dashboard interface may be presented that shows the user the current status of reaching the first target.

Additional portions of the UI may be presented including a team giving campaign status portion and a historical giving portion. Some of the data in the team campaign portion may be obfuscated with respect to underlying dollar amounts to protect the privacy of other team members. The historical giving portion may display historical giving amounts attributable (directly or indirectly through a match) to the user.

At operation 410, a selection of a charity is received via the second portion. For example, the user may use a drop-down menu to indicate the user's preference for a charity. The first target may include a type (e.g., “match,” “user funded,” etc.) that indicates a giving method for a charity. An indication of the type of the target may be presented in the second portion. For example, a message congratulating the user may be presenting indicating charity portal 102 may match donations up to $100. Additional UI elements may be presented depending on the type. For example, for a match, an input box may be presented to allow the user to enter in an amount to give to selected charity.

At operation 412, in an example, an electronic communication with the selected charity to transfer funds to the selected charity is initiated. An API of the charity may be used to first initiate a transfer with respect to user funds. Charity portal 102 may await confirmation from the charity of a successful transfer of funds before initiating a transfer of matching funds.

### Example Computer System

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

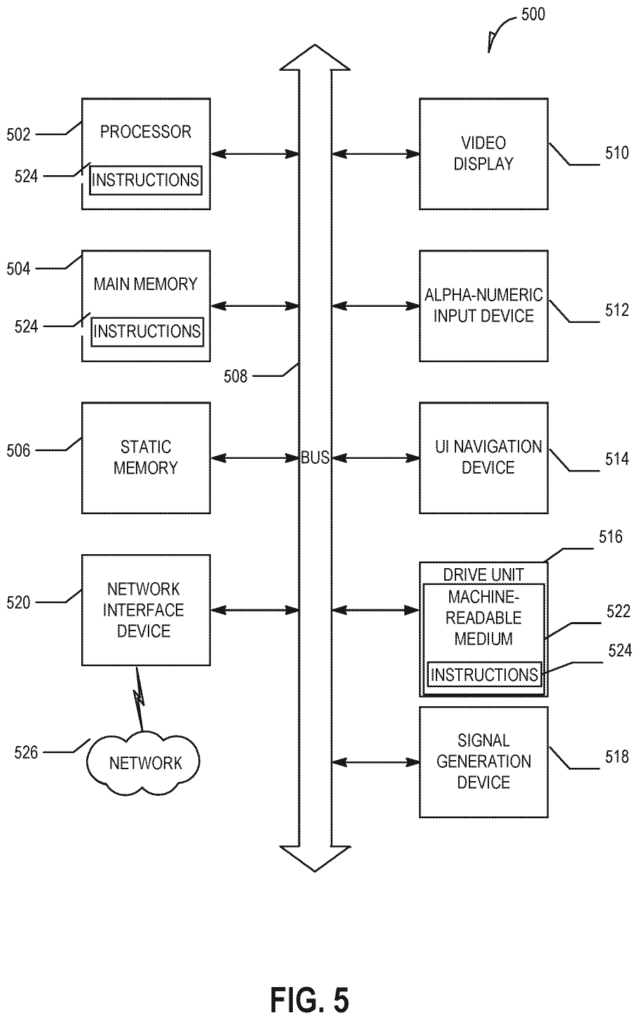

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A computer-implemented method comprising:
receiving, over a network interface, a status update request from a user;
in response to the request, updating a net worth calculation for the user;
determining that the net worth calculation exceeds a first target of a set of net worth targets;
determining if the first target was previously reached by the user;
transmitting, using a cryptographic protocol, a dashboard user interface to the user indicating whether the first target was previously reached by the user, the dashboard user interface including:
a first portion to present an indication that the user has met the first target; and
a second portion to list charities approved for receiving funds, the second portion requesting selection of a charity from the list of charities, the second portion configured to receive the selection of the charity;
receiving the selection of a charity at the dashboard user interface through the second portion; and
initiating an electronic communication that uses the cryptographic protocol, the electronic communication being sent to the selected charity to transfer funds to the selected charity when the first target was not previously reached by the user in response to receiving the selection of the charity at the dashboard interface, wherein if the first target was previously reached by the user, the electronic communication to transfer funds is not initiated.

2. The method of claim 1, wherein updating a net worth calculation for the user includes:
querying a plurality of data sources for value information associated with the user, wherein each of the plurality of data sources include a type of the data source.

3. The method of claim 2, wherein querying the plurality of data sources for value information associated with the user includes:
querying a first data source of the plurality of data sources using a first retrieval method when the type of the first data source is an affiliated data source, the first retrieval method using an authentication token; and
querying a second data source of the plurality of data sources using a second retrieval method when the type of the second data source is an unaffiliated data source, the second retrieval method using a screen scraping technique.

4. The method of claim 1, wherein the second portion of the user interface presents a method of giving for the charity.

5. The method of claim 1, further comprising:
determining that the first target has not been previously exceeded by the user before presenting the dashboard user interface.

6. The method of claim 1, further comprising:
presenting, in a third portion of the dashboard user interface, status of team giving campaigns associated with the user.

7. The method of claim 6, wherein net worth information of other users in a team campaign is obfuscated from presentation to the user.

8. The method of claim 1, further comprising:
presenting an animation in the dashboard user interface corresponding to a change in the net worth calculation of the user.

9. The method of claim 1, further comprising:
presenting, in a third portion of the dashboard user interface, historical giving amounts attributable to the user.

10. The method of claim 1, wherein presenting the dashboard user interface to the user includes transmitting the dashboard user interface to a computing device of the user for rendering on the computing device of the user.

11. A non-transitory computer readable medium comprising instructions, which when executed by at least one processor, configure the at least one processor to perform operations comprising:
receiving, over a network interface, a status update request from a user;
in response to the request, updating a net worth calculation for the user;
determining that the net worth calculation exceeds a first target of a set of net worth targets;
determining if the first target was previously reached by the user;
transmitting, using a cryptographic protocol, a dashboard user interface to the user indicating whether the first target was previously reached by the user, the dashboard user interface including:
a first portion to present an indication that the user has met the first target; and
a second portion to list charities approved for receiving funds, the second portion requesting selection of a charity from the list of charities, the second portion configured to receive the selection of the charity;
receiving the selection of a charity at the dashboard user interface through the second portion;
and
initiating an electronic communication that uses the cryptographic protocol, the electronic communication being sent to the selected charity to transfer funds to the selected charity when the first target was not previously reached by the user in response to receiving the selection of the charity at the dashboard interface, wherein if the first target was previously reached by the user, the electronic communication to transfer funds is not initiated.

12. The computer readable medium of claim 11, wherein updating a net worth calculation for the user includes:
querying a plurality of data sources for value information associated with the user, wherein each of the plurality of data sources include a type of the data source.

13. The computer readable medium of claim 12, wherein querying the plurality of data sources for value information associated with the user includes:
querying a first data source of the plurality of data sources using a first retrieval method when the type of the first data source is an affiliated data source, the first retrieval method using an authentication token; and
querying a second data source of the plurality of data sources using a second retrieval method when the type of the second data source is an unaffiliated data source, the second retrieval method using a screen scraping technique.

14. (canceled)

15. The computer readable medium of claim 11, wherein the at least one processor is further configured to perform an operation of:
determining that the first target has not been previously exceeded by the user before presenting the dashboard user interface.

16. A system comprising:
at least one processor;
a storage device comprising instructions, which when executed by the at least one processor, configure the at least one processor to perform operations comprising:
receiving, over a network interface, a status update request from a user;
in response to the request, updating a net worth calculation for the user;
determining that the net worth calculation exceeds a first target of a set of net worth targets;
determining if the first target was previously reached by the user;
transmitting, using a cryptographic protocol, a dashboard user interface to the user indicating whether the first target was previously reached by the user, the dashboard user interface including:
a first portion to present an indication that the user has met the first target; and
a second portion to list charities approved for receiving funds, the second portion requesting selection of a charity from the list of charities, the second portion configured to receive the selection of the charity;
receiving the selection of a charity at the dashboard user interface through the second portion; and
initiating an electronic communication that uses the cryptographic protocol, the electronic communication being sent to the selected charity to transfer funds to the selected charity when the first target was not previously reached by the user in response to receiving the selection of the charity at the dashboard interface, wherein if the first target was previously reached by the user, the electronic communication to transfer funds is not initiated.

17. The system of claim 16, wherein updating a net worth calculation for the user includes:
querying a plurality of data sources for value information associated with the user, wherein each of the plurality of data sources include a type of the data source.

18. The system of claim 17, wherein querying the plurality of data sources for value information associated with the user includes:
querying a first data source of the plurality of data sources using a first retrieval method when the type of the first data source is an affiliated data source, the first retrieval method using an authentication token; and
querying a second data source of the plurality of data sources using a second retrieval method when the type of the second data source is an unaffiliated data source, the second retrieval method using a screen scraping technique.

19. (canceled)

20. The system of claim 16, wherein the at least one processor is further configured to perform an operation of:
determining that the first target has not been previously exceeded by the user before presenting the dashboard user interface.
